(19) United States
(12) Patent Application Publication
(10) Pub. No.: US 2008/0208488 A1
(43) Pub. Date: Aug. 28, 2008

(54) Device for Detecting Impact and Use Thereof

(75) Inventors: Joe Shih-Horng Yang, Taipei Shien (TW); Wen-Yen Wang, Taipei Shien (TW); Juinn-Yan Chen, Fremont, CA (US)

Correspondence Address: WPAT, PC;INTELLECTUAL PROPERTY ATTORNEYS, 2030 MAIN STREET, SUITE 1300, IRVINE, CA, 92614, US

(73) Assignee: SAGITTARIUS LIFE SCIENCE CORP., Taipei Shien (TW)

(21) Appl. No.: 11/616,237

(22) Filed: Dec. 26, 2006

(51) Int. Cl. G01L 5/00; G08B 3/00; G06F 11/00; G06F 15/00

(52) U.S. Cl. 702/41; 73/862.391; 116/203; 116/67 R; 702/188; 702/150

(57) ABSTRACT

The present invention relates to a device for detecting an impact and use thereof.

### FIELD OF THE INVENTION

The present invention relates to a device for detecting an impact and use of the device such as a vest or a shooting target.

### BACKGROUND OF THE INVENTION

Taiwan patent No. 228931 disclosed an electronic shooting target of BB pellets, which comprises a target, several thin-film switches on the surface of the target, and various objects on the top of the thin-film switches. On the side of the target, there are several LEDs. On the back of the target, there is a circuit system which comprises a power supply, power switch, wire, music IC and several parallel wires. The output end of power supply is connected to power switch with wire outside of the target; the power switch is connected to LED with wire in a serial circuit; the negative end of LED is connected to the output end of music IC with parallel wire; the power switch is connected to the thin-film switch under various objects with wire in a serial circuit, and the other end of thin-film switch is connected to the input end of music IC with parallel wire; and the input end of power supply of music IC is connected to power switch, the negative end of music IC is connected to the negative end of power supply, and the output end of the music IC has an amplifier circuit.

Taiwan patent No. 290990 disclosed a wireless simulating electronic target, which can be used as an auxiliary material for impact practice such as combat, reconnaissance encounter, in door action, reservist muster, school's military training, entertaining survival game and etc. This invention comprises a target sensing module comprising a target sensing submodule, a controlling box submodule and a target driver submodule, wherein a specific sensor can receive pulse laser from laser controlling box to lift target, and wireless transmission module can communicate with a control machine or simplified remote; a laser controlling box module, installed on the barrel of the training gun, can emit instant pulse laser while pulling the trigger to mimic ballistics; a simplified remote comprising a switch with number 1 to 20 and a wireless transmission module to remotely control its corresponding target sensing module up to 100 meters; a control machine and a software program, wherein the software program can communicate with target sensing module through wireless transmission module to execute various impact training program such as lifting target, calculating score, printing, analyzing, and etc.; and a wireless transmission module installed on the target sensing module, simplified remote, and a control machine for easy communication between each other up to 300 meters without wire connection.

U.S. Pat. No. 6,247,700 disclosed a target having a support sheet (1) wherein are superimposed a layer (2) of conductive paint connected to a conductive wire (3), a layer (4) of dielectric material, a layer (5) of conductive paint connected to a conductive wire (6), a layer (7) of phosphor-based electroluminescent material and a layer (8) of transparent conductive material, being the conductive wires (3 and 6) attached to a connector (9) for connection of the shooting target to an alternating or direct-current transformer (10), a photovoltaic cell or a supply battery.

China patent application No. 95215591 disclosed an electronic shooting target with automatic reporting ring and displaying system. The shooting target comprises an arc number sensor, a encode circuit, and a radio transmission circuit. The shooting spot comprises a radio receiver, a displaying circuit, and a voice reporting ring circuit. According to the conductive property of bullets, when the bullets across the arc number encode sensor which is made of two layers of conductive material with an layer of insulating material in between, it triggers encode circuit sending out the number of pulse the same as the passed arcs. Then, the pulse is transmitted via a transmitting circuit and received by radio receiving circuit to restore displaying and to trigger voice report ring.

The convenience of utilization in the previously known techniques in examples listed above is not sufficient. Hence, a more convenient electronic target is in demand on the market.

### SUMMARY OF THE INVENTION

The present invention relates to a device for detecting an impact. The present invention further relates to a use of the device for detecting an impact.

### BRIEF DESCRIPTION OF THE DRAWINGS

FIG. 1 illustrates a device for detecting an impact of the present invention.

FIG. 2 shows an example of a target by the use of the device of the present invention.

FIG. 3 shows an example of a vest by the use of the device of the present invention.

Description of major parts in the present invention
10: a device for detecting an impact
20: silicon
30: soft printed circuit board with thin-film switches
40: industrial plastic
50: output wire
55: microprocessor
60: an electronic target in present invention
65: a score displaying device
70: BB pellet
100: competitor
110: light emitting diode (LED) which can emit light, and a buzzer which can inform all competitors that someone has been hit
120: computer
130: signal transmitted from a computer to a gun set

### DETAILED DESCRIPTION OF THE INVENTION

The present invention relates to a device for detecting an impact which comprises

(a) a flexible material which absorbs impacting force and recover flexibility after impacting;

(b) a soft printed circuit board with a circuit output wire, wherein the board is attached to one side of the material (a) and is susceptible to the impact; and

(c) a microprocessor connected to a circuit output wire for positioning a hitting position of the impact.

The flexible material used in the present invention is utilized as a buffering material for impacting. The flexibility of the material can also be utilized for sequential impacting events. The flexible material in the present invention includes but is not limited to the materials selected from the group consisting of rubber, sponge, silicon, resin, epoxy resin, latex foam, elastic fiber, polyurethane elastomer, vinyl sponge, and neoprene sponge. The preferred embodiment is silicon or latex foam.

The soft printed circuit board with thin-film switches in the present invention can be purchased easily on the market. The soft printed circuit board is deposited with thin-film switches in a distance of 0.01˜6 mm between each line. The preferred embodiment is 0.01˜5 mm. The more preferred embodiment is 0.01˜3 mm. An extensive thin-film switch layout on the soft printed circuit board is utilized to position impact precisely. The soft printed circuit board comprises a circuit output wire for connecting a microprocessor or other instruments.

The microprocessor for positioning a hitting position of an impact in the present invention is connected to a circuit output wire on the soft printed circuit board. The microprocessor can position a hitting position of an impact (such as BB pellet), transmit a signal for the impact to a computer, and turn the signal into sound or light. The microprocessor in the present invention can be connected to a wireless transmission device and provide a default score and reaction according to the hitting position using a computer software.

The present invention further comprises a support which is able to support the weight of this whole device. The material of the support is selected from the group consisting of plastic, wood, metal, glass, stone, acrylic, paper board, and fiber. The preferred embodiment is plastic for industrial application.

The device of the present invention can be used in preparing a hitting target. The hitting target can be attached with a light emitter (such as light emitting diode) to display the hitting position while the target being hit. Therefore, the hitting target in the present invention further comprises a displaying device of score summation which is convenient for a participant to know his/her own score.

The device of the present invention can be used in preparing a hitting vest. The hitting vest can make a sound and transmit a wireless signal to computer through a wireless transmission device while being hit. The computer can check the hitting situation and analyze its location. After confirming the hitting situation, the computer can send a signal to a gun set of a participant being hit prohibiting the gun set to fire again. The computer can simultaneously transmit a signal of the hitting situation and position to all participants. To the contrary, the computer can send a signal to the gun set of the participant being hit to fire again.

The term “impact” used in the present invention includes but is not limited to objects (such as BB pellet or BB paint ball) hitting the device of the present invention (such as a target or vest), or a fencing sword hitting the device of the present invention (such as a vest).

The following examples illustrate the present inventions and are not limited to the same.

### EXAMPLES

### EXAMPLE 1

### Device Preparation of Present Invention

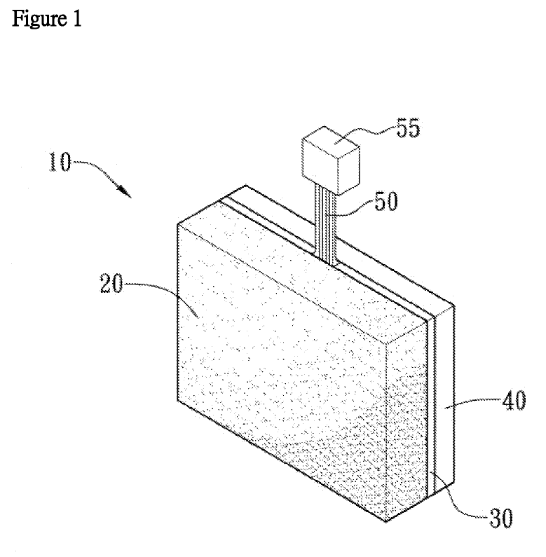

As shown in FIG. 1, silicon (20) and industrial plastic (40) were cut into the same size as (30) soft printed circuit board with thin-film switches. The cut silicon was attached to one side of the soft printed circuit board, and the cut industrial plastic was attached to the other side of the soft printed circuit board. Then, the output wire (50) on the printed circuit board was connected with microprocessor (55) which positioned a hitting position by an impact such as BB pellet to produce a device (10) of the present invention.

### EXAMPLE 2

### Preparation of Electronic Target

The device (10) prepared as in EXAMPLE 1 was cut into a circle. Concentric circles with various radiuses were drawn and labeled with various points (such as 10 points for the most concentric circle) on the top of silicon (20). A microprocessor (55) was connected with score displaying device (65) through output wire (50) to prepare an electronic target (60) of the present invention. Light emitting diode could be placed under sections of various points (such as 10 points for the most concentric circle) and connected to the soft printed circuit board of the electronic target (60) by wire in the present invention.

### EXAMPLE 3

### Preparation of Vest

A vest was made out of the device (10) in EXAMPLE 1 according to user sizes. Microprocessor (55) was connected to a wireless output device with wire.

### EXAMPLE 4

### Application of Electronic Target

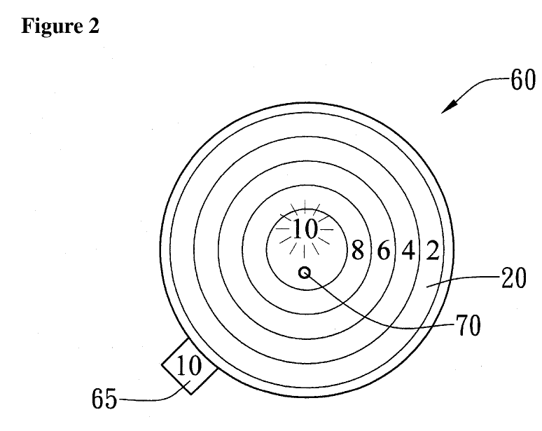

As shown in FIG. 2, the center of the electronic target (60) emitted light when BB pellets (70) hit the center of the electronic target, and the score of 10 points showed on a score displaying device (65).

### EXAMPLE 5

### Application of Vest

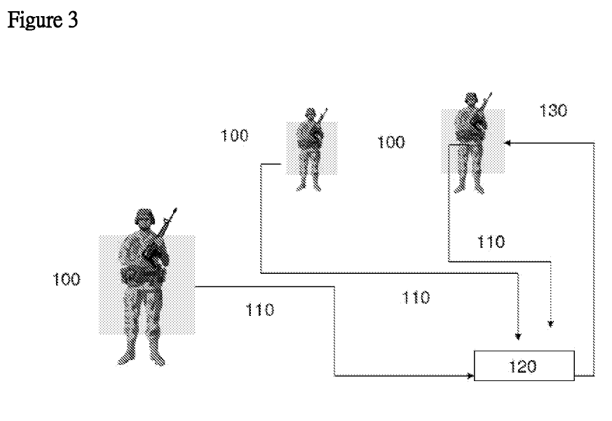

As shown in FIG. 3, when a vest of a participant (100) was hit by BB pellets, the light emitting diode would light up and a buzzer informed all participants that someone had been hit (110). Besides, the vest sent wireless signal to a receiver of a computer (120) to record the information, and the computer program checked the hit participant's situation and analyzed his/her location. If the participant was hit, the computer sent a signal to his/her gun set prohibiting his/her gun set to fire again (130).

What is claimed is:

1. A device for detecting an impact comprising
(a) a flexible material which absorbs impacting force and recover flexibility after impacting;
(b) a soft printed circuit board with a circuit output wire, wherein the board is attached to one side of the material (a) and is susceptible to the impact; and
(c) a microprocessor connected to a circuit output wire for positioning a hitting position of the impact.

2. The device of claim 1, wherein said device comprises a support which is able to support the weight of whole device.

3. The device of claim 1, wherein said flexible material is selected from the group consisting of rubber, sponge, silicon, resin, epoxy resin, latex foam, elastic fiber, polyurethane elastomer, vinyl sponge, and neoprene sponge.

4. The device of claim 2, wherein said support is selected from the group consisting of plastic, wood, metal, glass, stone, acrylic, paper board, and fiber.

5. The device of claim 1, wherein said soft printed circuit board is deposited with thin-film switches in a distance of 0.01˜6 mm between each line.

6. The device of claim 1, wherein said device is for use in preparing a hitting target.

7. The device of claim 6, wherein said hitting target further comprises a light emitting device indicating a hitting position.

8. The device of claim 1, wherein said microprocessor is connected with a wireless transmission device.

9. The device of claim 8, wherein said microprocessor provides a default score and reaction according to the hitting position.

10. The device of claim 9, wherein said microprocessor further comprises a displaying device showing hitting score summation.

11. The device of claim 1, which is for preparing a hitting vest.

12. The device of claim 1, wherein said impact is BB pellet, BB paint ball or fencing sword.

13. The device of claim 7, wherein said light emitting device is light emitting diode.

14. The device of claim 11, wherein said hitting vest makes a sound while being hit.

15. The device of claim 11, wherein said hitting vest sends a wireless signal to a computer through a wireless transmission device while being hit.

16. The device of claim 15, wherein said computer checks the hitting situation and analyzes location.

17. The device of claim 16, wherein said hitting situation is confirmed by a computer and a signal can be sent from the computer to a gun set of a participant being hit.

18. The device of claim 17, wherein said gun set permit or prohibit a gun set to fire again after a participant being hit.

19. The device of claim 17, wherein said gun set prohibits the gun set of a participant being hit to fire again after the hitting situation is confirmed by a computer.

20. The device of claim 17, wherein said computer sends a signal of the hitting situation and position to all participants after the hitting situation and position is confirmed by the computer.
